(19) United States
(12) Patent Application Publication
(10) Pub. No.: US 2014/0198050 A1
(43) Pub. Date: Jul. 17, 2014

(54) MULTIFUNCTION TOUCH KEYBOARD MODULE

(71) Applicant: KO JA (CAYMAN) CO., LTD., Grand Cayman (KY)

(72) Inventors: Yu-Kai LIN, Grand Cayman (KY); Wen-Chi HSU, Grand Cayman (KY)

(73) Assignee: KO JA (CAYMAN) CO., LTD., Grand Cayman (KY)

(21) Appl. No.: 13/740,994

(22) Filed: Jan. 14, 2013

(51) Int. Cl. G06F 3/02

(52) U.S. Cl. CPC G06F 3/02
USPC 345/169

(57) ABSTRACT

A multifunction touch keyboard module includes a touch panel. The touch panel includes an ordinary area and a function area. The ordinary area and the function area are opposite to trigger positions of keys. The ordinary area is used for keying texts or symbols. The function area is used for function keys. The ordinary area is switched to a mouse movement area when a switching condition is achieved. A user can touch the mouse movement area to control a mouse cursor of an electronic device. The user can use the ordinary area and the function area at the same time. The user can use the mouse movement area and the function area at the same time after the ordinary area is switched to the mouse movement area.

### BACKGROUND OF THE INVENTION

1. Field of the Invention

The present invention relates to a keyboard module, and especially relates to a multifunction touch keyboard module integrating an ordinary area (also can be referred to a text-input area), a function area, and a mouse movement area.

2. Description of the Related Art

The touch technology is progressing every day. Therefore, the traditional physical keys for the electronic devices are replaced by the touch keys or touch screens.

For example, the touch screens for the electronic devices (such as smart phones or Tablet PCs) are used as display units and input units. Therefore, the physical keyboards are not required for the smart phones or Tablet PCs. The users use the touch screens to operate the electronic devices (for example, keying texts or symbols). The space occupied by the physical keyboard is saved. The size of the screen is larger, and the weight of the electronic device is lighter.

However, keying texts or symbols on the touch screen is not as convenient as keying texts or symbols on the physical keyboard. Therefore, the user will want to use an external physical keyboard for keying a lot of texts or symbols (such as writing reports or replying emails). Keying texts or symbols on the physical keyboard is more convenient and faster than keying texts or symbols on the touch screen.

However, the related art external keyboard does not provide mouse functions. The user still has to use the touch screen for mouse functions, or an external mouse will be required. Therefore, it will be convenient if keyboard functions and mouse functions are integrated in a module.

### SUMMARY OF THE INVENTION

An object of the present invention is to provide a multifunction touch keyboard module. A first area of the multifunction touch keyboard module is switchable between an ordinary area and a mouse movement area. The ordinary area is used for keying texts or symbols. The mouse movement area is used for moving a mouse cursor of an electronic device.

A function area of the multifunction touch keyboard module is used for function keys. The function area is different from the first area. Therefore, the function area is preserved while the first area is switched between the ordinary area and the mouse movement area. The user can control the mouse cursor on the mouse movement area and use function keys on the function area at the same time.

In order to achieve the object mentioned above, the multifunction touch keyboard module includes a touch panel. The touch panel includes the ordinary area and the function area. The ordinary area and the function area are opposite to trigger positions of keys. The ordinary area is used for keying texts or symbols. The function area is used for function keys. The ordinary area is switched to the mouse movement area when a switching condition is achieved. The user can touch the mouse movement area to control the mouse cursor.

The efficiency of the present invention is that the ordinary area for keying texts or symbols and the mouse movement area for controlling the mouse cursor are integrated in the first area of the multifunction touch keyboard module. The first area is switchable between the ordinary area and the mouse movement area. Moreover, the function area is preserved whether the first area is switched to the ordinary area or the mouse movement area. Therefore, the user can control the mouse cursor and use function keys at the same time, so that some special operations (such as selecting a plurality of files by the mouse cursor) will be achieved.

### BRIEF DESCRIPTION OF DRAWING

FIG. 1A shows a diagram of a first embodiment of the multifunction touch keyboard module of the present invention.

FIG. 1B shows a diagram of a second embodiment of the multifunction touch keyboard module of the present invention.

FIG. 2 shows a diagram of a third embodiment of the multifunction touch keyboard module of the present invention.

FIG. 3 shows a diagram of a first status of the multifunction touch keyboard module of the present invention.

FIG. 4 shows a diagram of a second status of the multifunction touch keyboard module of the present invention.

FIG. 5 shows a flow chart of the present invention.

FIG. 6 shows a diagram of a third status of the multifunction touch keyboard module of the present invention.

### DETAILED DESCRIPTION OF THE INVENTION

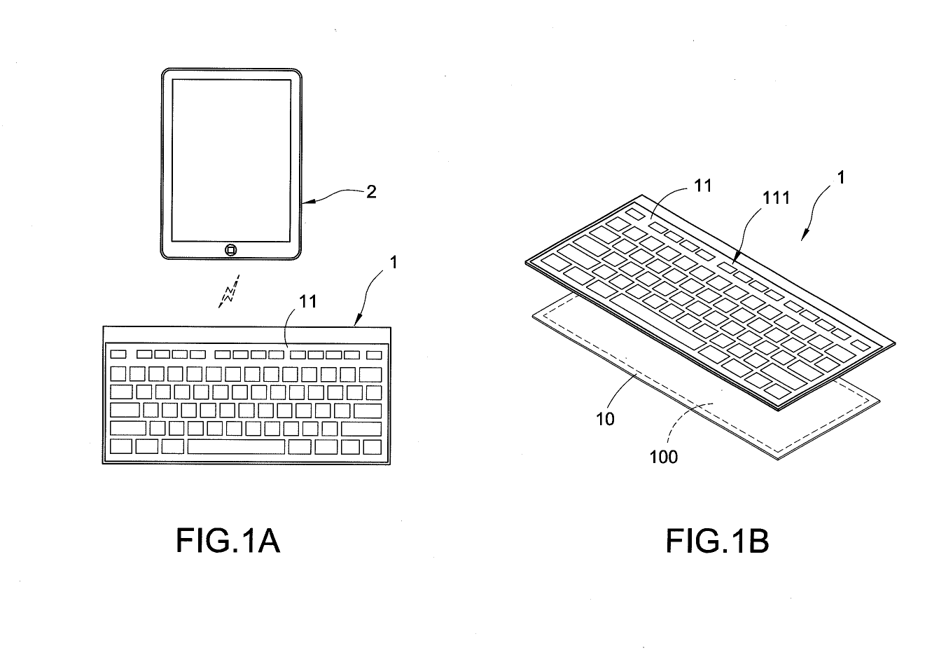

FIG. 1A shows a diagram of a first embodiment of the multifunction touch keyboard module of the present invention. FIG. 1B shows a diagram of a second embodiment of the multifunction touch keyboard module of the present invention. The present invention is to provide a multifunction touch keyboard module 1. The multifunction touch keyboard module 1 is wirelessly (or with wires) connected to an electronic device 2. The multifunction touch keyboard module 1 is used as an external keyboard for the electronic device 2.

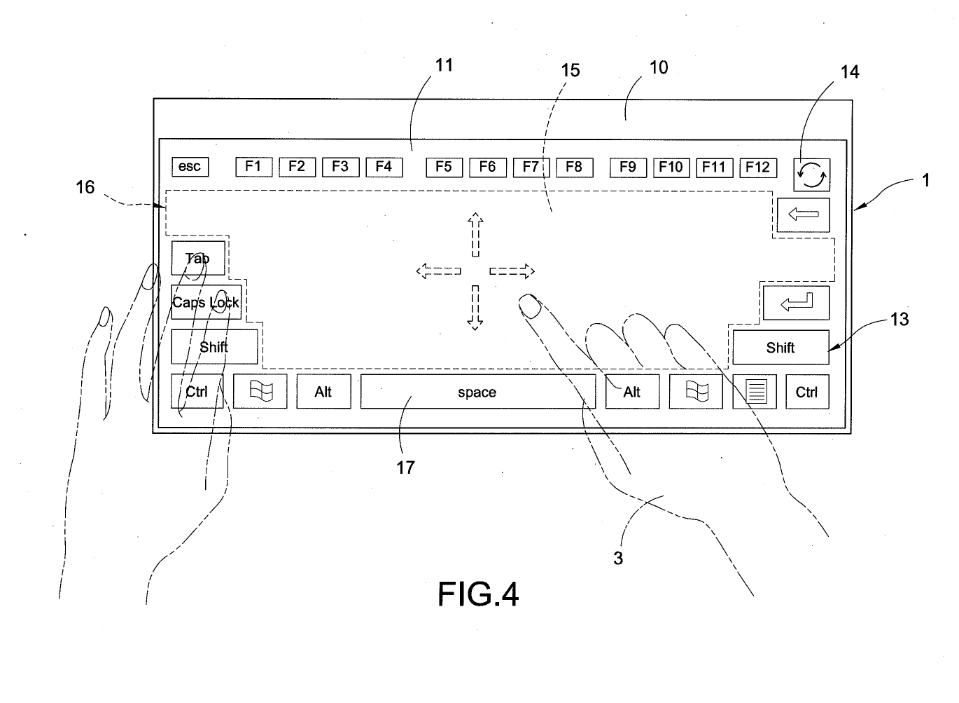

For example, the electronic device 2 is a Tablet PC without a physical keyboard. The electronic device 2 is connected to the multifunction touch keyboard module 1 through the Bluetooth, the radio frequency, the physical wires connection, and so on. Therefore, a user 3 (as shown in FIG. 4) can operate the multifunction touch keyboard module 1 to type texts or symbols for the electronic device 2 or to control the electronic device 2.

As shown in FIG. 1B, the multifunction touch keyboard module 1 includes a touch panel 10 and an induced circuit 100 arranged on the touch panel 10. Therefore, a coordinate of a touched point (on the touch panel 10) touched by the user 3 will be detected by the induced circuit 100 after the touch panel 10 is touched by the user 3. Then, a trigger position of a key opposite to the touched point is judged (decided). In this embodiment, the touch panel 10 is mainly divided into a plurality of trigger positions for a plurality of input keys and a plurality of function keys. The input keys are, for examples but not limited to, text input keys or symbol input keys. The function keys are, for examples but not limited to, the Ctrl key or the Enter key, and so on.

In this embodiment, the multifunction touch keyboard module 1 further includes a nameplate 11 arranged (pasted) on the touch panel 10 and the induced circuit 100. Therefore, the user 3 may tell the trigger positions of these keys on the touch panel 10. Moreover, the multifunction touch keyboard module 1 further includes a plurality of key blocks 111 arranged on the nameplate 11. The key blocks 111 and the nameplate 11 can be integrated in multi-bump shape. Or the key blocks 111 can be a plurality of patterns pasted or printed on the nameplate 11. Moreover, the positions of the key blocks 111 are opposite to the trigger positions of the input keys and function keys.

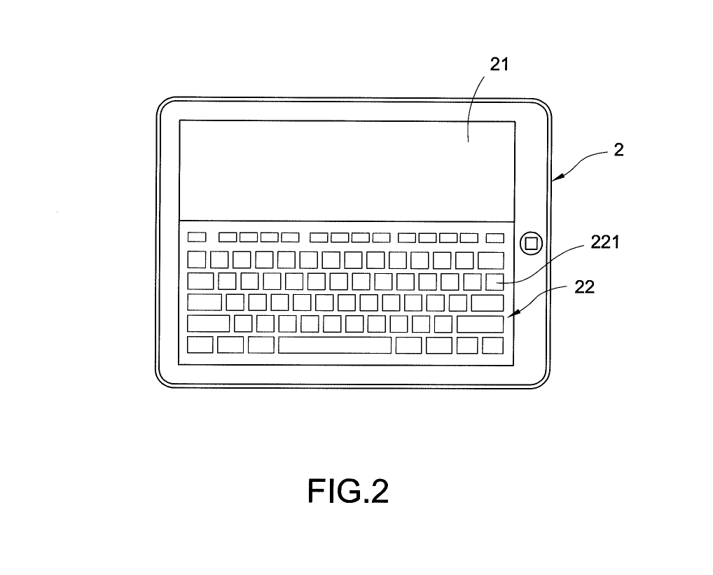

FIG. 2 shows a diagram of a third embodiment of the multifunction touch keyboard module of the present invention. In this embodiment, the multifunction touch keyboard module 1 is a touch screen 21 of the electronic device 2. A base of the touch screen 21 is a touch panel which is the same as the touch panel 10 mentioned above. A virtual keyboard 22 is shown on the touch screen 21 when a keyboard mode of the electronic device 2 is started. The virtual keyboard 22 shows a plurality of key blocks 221. Positions of the key blocks 221 are opposite to trigger positions of a plurality of input keys and a plurality of function keys. In this embodiment, the efficiency of the virtual keyboard 22 is the same as the nameplate 11 mentioned above. Therefore, the user 3 can tell the trigger positions of these keys.

As mentioned above, the multifunction touch keyboard module 1 of the present invention can be achieved by the touch panel 10 and the nameplate 11, or by the touch screen 21 and the virtual keyboard 22 of the electronic device 2. However, in order to describe the present invention easily, the touch panel 10 and the nameplate 11 will be taken as examples in the following embodiments, but the present invention is not limited to it.

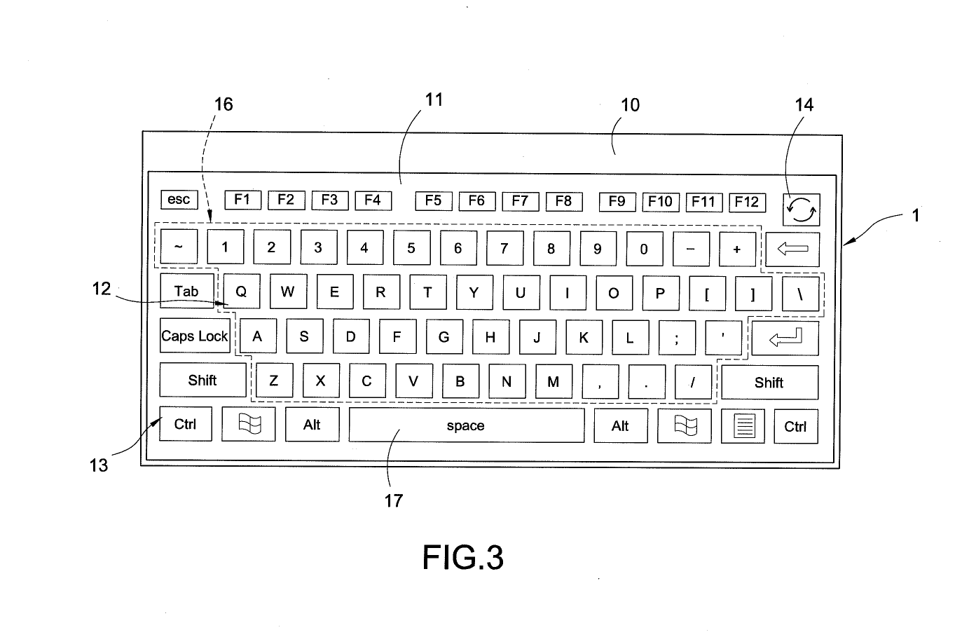

FIG. 3 shows a diagram of a first status of the multifunction touch keyboard module of the present invention. The touch panel 10 mainly includes a first area (not shown in FIG. 3) and a second area (not shown in FIG. 3). In another word, the touch panel 10 is mainly divided into the first area and the second area. The first area and the second area are not overlapped. The second area is arranged opposite to the first area (the second area is around the first area). The multifunction touch keyboard module 1 mainly includes an ordinary area 12 and a function area 13. The ordinary area 12 is on the first area of the touch panel 10. The function area 13 is on the second area of the touch panel 10. In another word, the ordinary area 12 and the function area 13 are not overlapped.

The ordinary area 12 is mainly opposite to the trigger positions of the input keys of the touch panel 10. More specifically, the input keys mentioned in this embodiment are, for examples but not limited to, the “A” key to the “Z” key, the “0” key to the “9” key (texts), the “˜” key, the “−” key, the “=” key, the “\” key (symbols), and so on.

The function area 13 is mainly opposite to the trigger positions of the function keys of the touch panel 10. More specifically, the function keys mentioned in this embodiment are, for examples but not limited to, the Shift key, the Ctrl key, the Alt key, the Windows key, the Enter key, the Backspace key, the Esc key, the Tab key, the Caps Lock key, the Fn key, the F1 key to the F12 key, and so on.

The main feature of the present invention is that the multifunction touch keyboard module 1 further includes a mouse movement area 15 (as shown in FIG. 4) on the first area of the touch panel 10. In another word, the mouse movement area 15 and the ordinary area 12 are overlapped. The first area is one of the ordinary area 12 and the mouse movement area 15 at the same time. The ordinary area 12 and the mouse movement area 15 cannot exist at the same time. A switching condition is recorded in the multifunction touch keyboard module 1. The first area is switched from the ordinary area 12 to the mouse movement area 15 or from the mouse movement area 15 to the ordinary area 12 when the switching condition is achieved.

The user 3 can use the input keys of the ordinary area 12 and the function keys of the function area 13 at the same time when the first area is the ordinary area 12 and the second area is the function area 13. The user 3 can control a mouse cursor and use the function keys of the function area 13 at the same time when the first area is the mouse movement area 15 and the second area is the function area 13. As shown in FIG. 3, the user 3 can use the text input keys, the symbol keys, and the function keys at the same time when the first area is the ordinary area 12. Beside keying texts or symbols, some special operations can be achieved as well (such as pressing the Ctrl key and the “C” key at the same time to copy, or pressing the Ctrl key and the “V” key at the same time to paste).

FIG. 4 shows a diagram of a second status of the multifunction touch keyboard module of the present invention. As shown in FIG. 4, the first area is switched from the ordinary area 12 to the mouse movement area 15 when the switching condition is achieved. Therefore, the user 3 can touch the mouse movement area 15 by fingers or a touch pen (not shown in FIG. 4) to control the mouse cursor (not shown in FIG. 4) of the electronic device 2. Moreover, as mentioned above, the user 3 can use the function keys of the function area 13 and the mouse movement area 15 at that same time. For example, the user 3 can press and hold the Ctrl key of the function area 13, then control the mouse cursor to select the files of the electronic device 2 to move, open, or delete the files at the same time. The user 3 can achieve the operations which require the physical keyboard and mouse.

As mentioned above, the second area is the function area 13, no matter the first area is the ordinary area 12 or the mouse movement area 15. Therefore, in this embodiment, the multifunction touch keyboard module 1 further includes at least a marked unit 16 arranged around the first area. The boundary of the first area is indicated by the marked unit 16. The user 3 is aware of the boundary of the first area. The marked unit 16 is a light-emitting unit or a plurality of the light-emitting units. The light-emitting unit is, for example, a light-emitting diode. The light-emitting unit is electrically connected to the touch panel 10 and is around the first area. The light-emitting unit is lighting for indicating the boundary of the first area. Therefore, the user 3 is aware of the operation boundary of the ordinary area 12 and the mouse movement area 15.

As shown in FIG. 3 and FIG. 4, in this embodiment, the touch panel 10 further includes a third area (not shown in FIG. 3 and FIG. 4) which is not overlapped the first area and the second area. In another word, the touch panel 10 is divided into the first area, the second area, and the third area. The third area is arranged opposite to the second area and the first area. The multifunction touch keyboard module 1 further includes a switching area 14 which is on the third area. The position of the switching area 14 is opposite to a trigger position of a switching key (not shown in FIG. 3 and FIG. 4) of the multifunction touch keyboard module 1. Therefore, the first area is switched from the ordinary area 12 to the mouse movement area 15 or from the mouse movement area 15 to the ordinary area 12 when the switching key is touched by the user 3 (judged by the multifunction touch keyboard module 1).

Moreover, the multifunction touch keyboard module 1 is configured to record at least one set of function key combination, for example, the Ctrl key and the Shift key, the Alt key and the Shift key, or the Fn key and anyone of the F1 to F12 key. Therefore, the first area is switched from the ordinary area 12 to the mouse movement area 15 or from the mouse movement area 15 to the ordinary area 12 when the function key combination mentioned above is touched by the user 3 (judged by the multifunction touch keyboard module 1).

In this embodiment, the switching between the ordinary area 12 and the mouse movement area 15 is achieved with the function key combination, so the third area and the switching area 14 don't exist anymore. However, the contents mentioned above are just embodiments, and the present invention is not limited to it. The multifunction touch keyboard module 1 shall be configured to switch the ordinary area 12 and the mouse movement area 15 with any other methods.

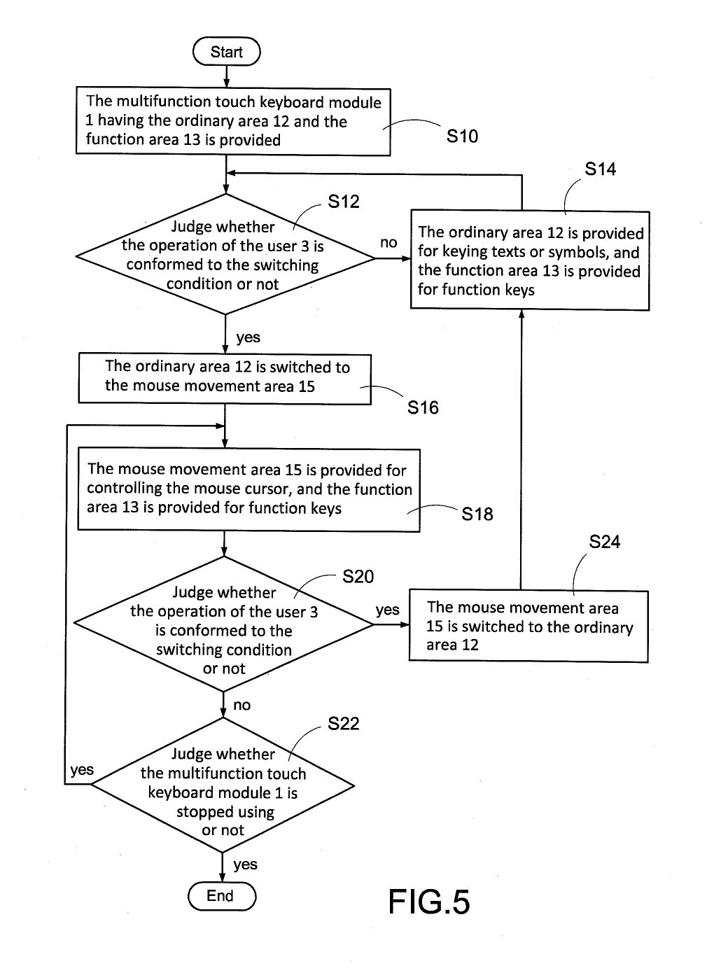

FIG. 5 shows a flow chart of the present invention. The process of the present invention includes following steps.

Step S10: The multifunction touch keyboard module 1 having the ordinary area 12 and the function area 13 is provided. Then the process goes to a step S12.

Step S12: Judge whether the operation of the user 3 is conformed to the switching condition or not. If not, the process goes to a step S14. If yes, the process goes to a step S16.

Step S14: The ordinary area 12 is provided for keying texts or symbols, and the function area 13 is provided for function keys. Then the process goes back to the step S12.

Step S16: The ordinary area 12 is switched to the mouse movement area 15. Then the process goes to a step S18.

Step S18: The mouse movement area 15 is provided for controlling the mouse cursor, and the function area 13 is provided for function keys. Then the process goes to a step S20.

Step S20: Judge whether the operation of the user 3 is conformed to the switching condition or not. If not, the process goes to a step S22. If yes, the process goes to a step S24.

Step S22: Judge whether the multifunction touch keyboard module 1 is stopped using or not. If not, the process goes back to the step S18. If yes, the process is finished.

Step S24: The mouse movement area 15 is switched to the ordinary area 12. Then the process goes back to the step S14.

According to the process mentioned above, before the multifunction touch keyboard module 1 is stopped using (for examples, the multifunction touch keyboard module 1 is powered off or disconnected to the electronic device 2), the function area 13 is provided for function keys, and the ordinary area 12 is provided for keying texts or symbols, and the mouse movement area 15 is provided for controlling the mouse cursor. As mentioned above, the ordinary area 12 and the mouse movement area 15 are alternative.

Moreover, the first area can be pre-defined as the ordinary area 12 or the mouse movement area 15 (depending on requirements) when the multifunction touch keyboard module 1 is used or connected to the electronic device 2 at the first time.

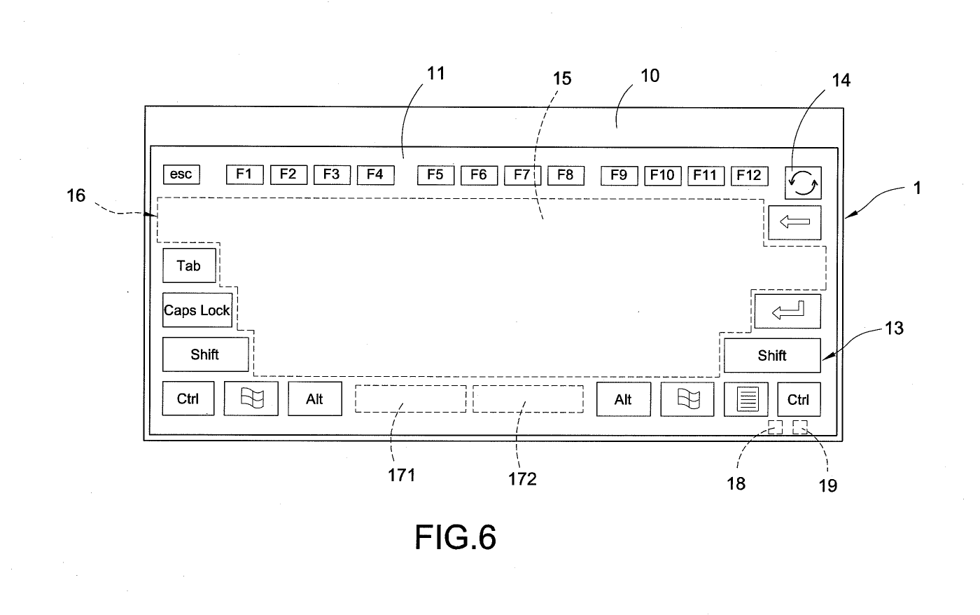

FIG. 6 shows a diagram of a third status of the multifunction touch keyboard module of the present invention. In this embodiment, the touch panel 10 further includes a fourth area (not shown in FIG. 6) which is not overlapped the first area, the second area, and the third area. In another word, the touch panel 10 is divided into the first area, the second area, the third area, and the fourth area. The fourth area is arranged opposite to the second area and the first area. The multifunction touch keyboard module 1 further includes a control area 17 (as shown in FIG. 4) on the fourth area. The control area 17 is opposite to a trigger position of a space key of the multifunction touch keyboard module 1 when the first area is the ordinary area 12. Therefore, the ordinary area 12 is provided for keying texts or symbols, and the control area 17 is provided for keying a blank space.

The control area 17 is opposite to trigger positions of a mouse left key 171 and a mouse right key 172 when the first area is the mouse movement area 15. Therefore, the mouse movement area 15 is provided for controlling the mouse cursor, and the control area 17 is provided for pressing the mouse left key 171 and the mouse right key 172.

Moreover, the touch keyboard module 1 is configured to provide feedback messages when the touch panel 10 is touched by the user 3 successfully. As shown in FIG. 6, the multifunction touch keyboard module 1 further includes a sound unit 18 (such as a speaker) electrically connected to the touch panel 10. The sound unit 18 is configured to send out a sound message when the touch panel 10 is touched by the user 3 successfully. Moreover, the multifunction touch keyboard module 1 further includes a vibration unit 19 electrically connected to the touch panel 10. The vibration unit 19 is configured to send out a vibration message when the touch panel 10 is touched by the user 3 successfully. However, the feedback messages mentioned above are just embodiments. The present invention is not limited to it.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multifunction touch keyboard module including:
a touch panel including a first area and a second area, the second area arranged opposite to the first area;
an ordinary area on the first area of the touch panel, the ordinary area opposite to trigger positions of a plurality of input keys;
a function area on the second area of the touch panel, the function area opposite to trigger positions of a plurality of function keys; and
a mouse movement area on the first area of the touch panel, the mouse movement area overlapped the ordinary area,
wherein the first area is switched between the ordinary area and the mouse movement area when a switching condition is achieved.

2. The multifunction touch keyboard module in claim 1, wherein the function keys include at least one of a shift key, a ctrl key, an alt key, a windows key, an enter key, a backspace key, an esc key, a tab key, a caps lock key, an fn key, and one of f1 key to f12 key.

3. The multifunction touch keyboard module in claim 1, further including at least a marked unit arranged around the first area, the marked unit configured to indicate a boundary of the first area.

4. The multifunction touch keyboard module in claim 1, wherein the ordinary area is opposite to trigger positions of a plurality of text input keys and a plurality of symbol input keys.

5. The multifunction touch keyboard module in claim 4, further including a switching area, wherein the touch panel further includes a third area; the switching area is on the third area; the switching area is opposite to a trigger position of a switching key; the switching condition is achieved if the switching key is touched; the third area is arranged opposite to the second area and the first area.

6. The multifunction touch keyboard module in claim 4, wherein the multifunction touch keyboard module is configured to record at least a set of function key combination; the switching condition is achieved if the function key combination is touched.

7. The multifunction touch keyboard module in claim 4, further including:
a nameplate arranged on the touch panel; and
a plurality of key blocks arranged on the nameplate,
wherein positions of the key blocks are opposite to trigger positions of the input keys and the function keys.

8. The multifunction touch keyboard module in claim 4, further including a control area, wherein the touch panel further includes a fourth area; the control area is on the fourth area; the control area is opposite to a trigger position of a space key when the first area is the ordinary area;
the control area is opposite to trigger positions of a mouse left key and a mouse right key when the first area is the mouse movement area; the fourth area is arranged opposite to the second area and the first area.

9. The multifunction touch keyboard module in claim 4, further including a sound unit electrically connected to the touch panel, the sound unit configured to send out a sound message when the touch panel is touched successfully.

10. The multifunction touch keyboard module in claim 4, further including a vibration unit electrically connected to the touch panel, the vibration unit configured to send out a vibration message when the touch panel is touched successfully.
